(19) United States
(12) Patent Application Publication
(10) Pub. No.: US 2003/0014672 A1
(43) Pub. Date: Jan. 16, 2003

(54) Authentication protocol with dynamic secret

(76) Inventors: Meera Desikamani, Phoenix, AZ (US); Changguan Fan, Chandler, AZ (US); Brian R. Haug, Chandler, AZ (US)

Correspondence Address: TROP PRUNER & HU, PC, 8554 KATY FREEWAY, SUITE 100, HOUSTON, TX, 77024, US

(21) Appl. No.: 09/905,625

(22) Filed: Jul. 13, 2001

(51) Int. Cl. H04L 9/32

(52) U.S. Cl. 713/202

(57) ABSTRACT

A method and system for enabling a dynamic secret security value, such as a PIN, and for maintaining synchronization of copies of that value stored on two communicating devices such as a server and an appliance.

### BACKGROUND OF THE INVENTION

1. Technical Field of the Invention

The present invention relates generally to digital security, and more specifically to an authentication protocol for use between digital devices which wish to communicate with each other.

2. Background Art

Authentication is the well-known technology with which a communicating entity verify that another entity is who it claims to be. In some instances, the entities may be people, in others they may be, for example, digital devices such as computers, telephones, cash machines, or the like.

Existing authentication protocols use a predetermined secret to authenticate the entity. For example, a user is required to provide a password in order to log on to a network such as his internet service provider (ISP); a user is required to enter his personal identification number (PIN) in order to withdraw cash from an automated teller machine (ATM); a first computer is required to encrypt a message using its private key so a second computer can decrypt that message using the first computer's public key to prove that only the first computer could have done the initial encryption; a garage door opener remote control is required to send a unique code so only that remote will open the garage door; automobile remote door openers should have relatively unique values so they only open the correct car's doors; a cell phone sends a unique identifier so the system only charges the customer with calls from his own cell phone.

In such protocols, the secret remains static over time, and is therefore increasingly subject to attack by hackers or the like, who may attempt to determine the secret by brute force methods. In some cases, they may be able to break the secret a piece at a time, such as by periodically seeing individual numbers in a bank vault's combination.

It is undesirable that the secret should be compromised. It is further undesirable that, if it is compromised, the secret should remain valid and usable for an extended period of time. As long as the compromised secret remains unchanged, unauthorized persons or devices who possess it are free to use it for their perhaps nefarious purposes.

There are known technologies for non-static, or dynamic, secrets. For example, so-called “rolling code” garage door openers and car door openers periodically change the value of their secret. In these cases, it is necessary for the other entity—the garage door opener remote control or the automobile—to change their copy of the secret, so the two halves remain synchronized. Otherwise, the devices would suddenly stop working with each other.

It is desirable to provide an authentication protocol with dynamic secret, suitable for use in more sophisticated digital communications.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 illustrates one exemplary embodiment of a system in which this invention may be embodied and practiced.

FIG. 2 illustrates a flowchart of one exemplary embodiment of a method for practicing the invention.

FIG. 3 illustrates a flowchart of one exemplary embodiment of a method for attempting to recover from lost PIN synchronization.

### DETAILED DESCRIPTION

The invention will be illustrated in terms of an exemplary embodiment in which the two communicating entities are a web appliance and an ISP server communicating over the internet. However, the skilled reader will readily appreciate that the invention is not limited to this particular embodiment, and that the invention will have applicability in a wide variety of situations and technologies. By way of example only, and not as an exhaustive list, such situations and technologies may include: cellular telephones, instant messaging devices, pagers, ATMs, smartcards, cable set-top boxes, and other suitable technologies.

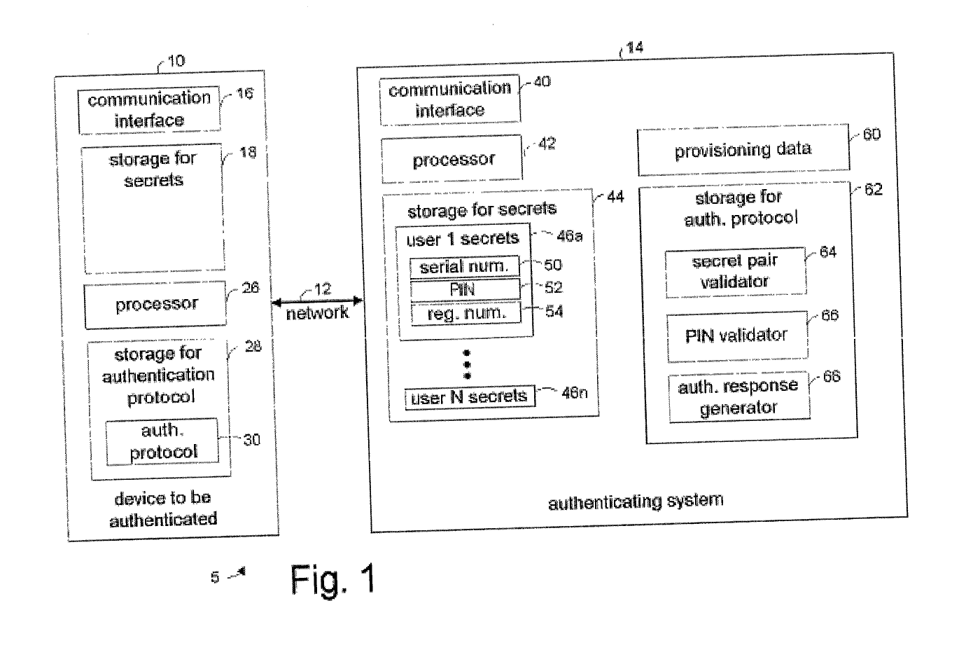

FIG. 1 shows one embodiment of a system 5 in which the invention may be practiced, or which may be constructed according to the invention. The system includes a first device 10 coupled via a network 12 to a second device 14. The first device may be termed a device to be authenticated 10, and the second device may be termed an authenticating device 14. In the exemplary system to be discussed, the first device is a web appliance 10 and the second device is an ISP server 14.

The web appliance includes a communication interface 16 which connects to the network over a port (not shown). In one embodiment, the communication interface may be a modem for connecting to the internet 12 over a telephone system (not shown). In other embodiments, the communication interface may be a digital subscriber line (DSL) interface, or a wireless interface such as Bluetooth, or an infrared interface, or a satellite interface, or a cable modem, or any other suitable mechanism.

The web appliance further includes storage 18 for storing the authentication secrets such as a serial number 20, a PIN 22, and a registration number 24. In various embodiments, the secrets may be different, and/or may be stored in separate storage.

The web appliance also includes a processor 26 for performing logic operations. In some embodiments, the processor may be a general purpose microprocessor (CPU). In others, it may be a digital signal processor (DSP), an analog device, dedicated fixed-purpose circuitry, a hybrid, or other suitable mechanism.

The web appliance includes storage 28 for storing the client side of the authentication protocol 30. In some embodiments, this may include software or other instructions which cause the processor to perform the method of the invention.

The ISP server includes a communication interface 40 of any suitable type for connecting the ISP server to the network. The ISP server further includes a processor 42 for performing logic operations. The processor may, as explained above, be any suitable form of processing device.

The ISP server includes storage 44 for storing the secrets 46a-n of a plurality of customers' web appliances. The stored secrets may, in various embodiments, include a serial number 50, a PIN 52, and a registration number 54, for the respective web appliance.

The ISP server further includes storage 60 for storing provisioning data for the various web appliances, to be downloaded to them when they need updating or re-provisioning, or upon initial provisioning.

The ISP server further includes storage 62 for storing the server side of the authentication protocol. In some embodiments, that may include software or other instructions or the like for causing the server's processor to perform the method of the invention. These routines may include, for example, a secret pair validator 64, a PIN validator 66, and an authentication response generator 68.

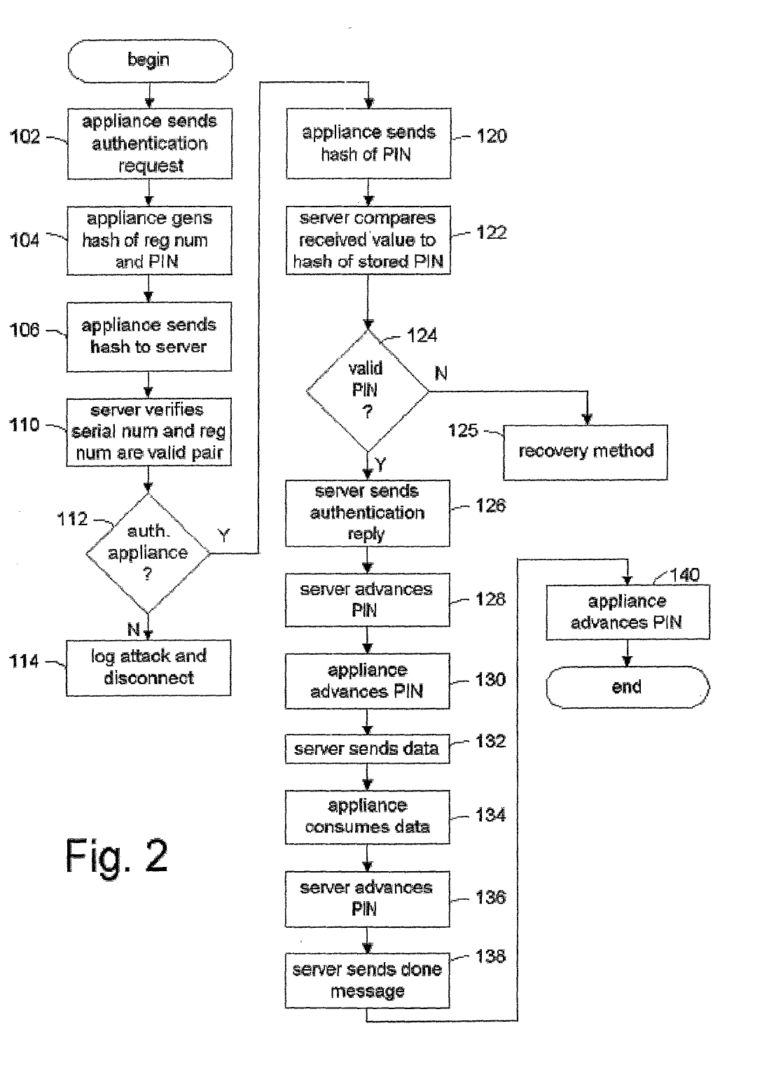

FIG. 2 illustrates one exemplary method of the invention. The method begins with the web appliance sending (102) an authentication request to the ISP server. Typically, this will be upon dialup or other connection. The server then authenticates the web appliance.

In one embodiment, the following methodology is used for authentication; other methodologies are usable in conjunction with this invention. The web appliance generates (104) a hash or other suitable representation of its PIN and registration number, and sends (106) this value to the server. The server verifies (110) that the serial number and registration number are a valid pair by comparing the values obtained from the client against those stored in the database. If (112) the pair is not valid, the server takes (114) appropriate measures, such as by logging the suspected hacker attack and terminating the appliance's connection. If the pair are valid, authentication continues.

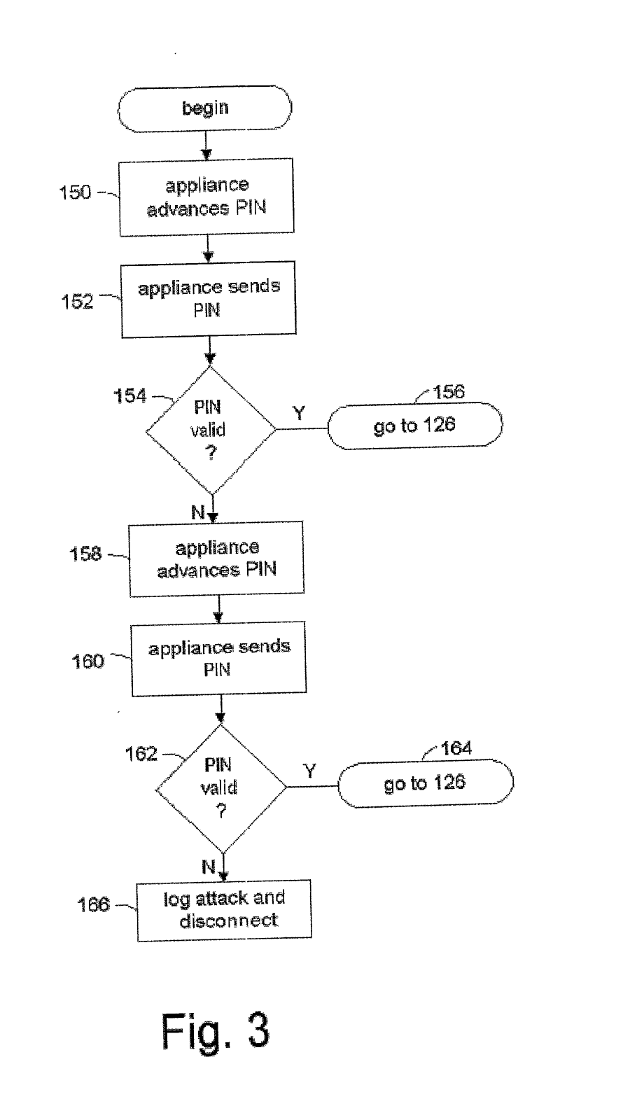

The server also verifies the correct value of the PIN by computing its own hash using the registration number provided by the web appliance with the server's stored copy of the PIN and comparing the result against the hash value received from the web appliance. If the PIN is thus determined to be not valid, the system may optionally execute a recovery method (125) (as described in FIG. 3). However, if (124) the PIN is valid, the server sends (126) an authentication reply to the web appliance, the server advances (128) its copy of that web appliance's PIN, and the web appliance advances (130) its copy of the PIN. In one embodiment, the PIN is a large number stored as an 80-byte array, and the advancement includes incrementing the PIN by a predetermined number such as one. Other advancement strategies are certainly within the scope of this invention. For example, the PIN could be multiplied, divided, or subtracted by a predetermined value, or some mathematical function could be applied to it such as a square root, sine, raising to a power, incrementing by a dynamically calculated value, or any other function, so long as both the server and the web appliance are capable of performing the substantially identical operation so their respective copies of the PIN stay adequately synchronized. In some embodiments, it may not be required that the values remain exactly equal, but in many this will be required.

The server then sends (132) any data that it needs to send to the web appliance or which the web appliance has requested. In some cases, this may be provisioning data. The web appliance receives and consumes (134) the data.

After sending the data, the server again advances (136) its copy of the PIN, and sends (138) a message to the web appliance indicating that the data transfer is complete. In response to receiving the done message, the web appliance advances (140) its copy of the PIN, and the authentication ends.

FIG. 3 illustrates one exemplary recovery method that may be used if the two copies of the PIN get out of synch. The recovery method begins with the web appliance advancing (150) its copy of the PIN, and sending (152) this advanced copy to the server. If (154) the server reply indicates that the PIN is valid, then operation may continue (156) at block 126 of the main method (shown in FIG. 2). If the PIN is still not valid, then the web appliance again advances (158) its copy of the PIN and sends (160) it to the server. If (162) the server indicates that the PIN is valid this time, operation may continue (164) at block 126 of the main method. Otherwise, the server may assume that it is under attack from an unauthorized appliance, and may log the attack and disconnect (166) from the appliance.

With reference again to FIG. 2, it may be noted that in some embodiments, the once-advanced PINs (at blocks 128 and 130) are not stored into the respective storage areas (18 and 44 in FIG. 1) of the web appliance and the server, but may be maintained as temporary values such as in memory rather than being written to disk. In such embodiments, the recovery method may be slightly altered such that the web appliance double-advances its PIN before sending it to the server, and may only make the one attempt. This will accommodate recovery in the situation where the server and appliance have made their single advancement of their copies of the PIN, the server has sent its data and then re-advanced and stored its PIN, but the connection fails or some other similar error occurs and the appliance does not receive the done message and so does not re-increment nor store its PIN, leaving the appliance's copy two advancements behind the server's copy of the PIN. The reader will appreciate that there are many variations on this theme which are within the scope of this invention.

The reader should appreciate that drawings showing methods, and the written descriptions thereof, should also be understood to illustrate machine-accessible media having recorded, encoded, or otherwise embodied therein instructions, functions, routines, control codes, firmware, software, or the like, which, when accessed, read, executed, loaded into, or otherwise utilized by a machine, will cause the machine to perform the illustrated methods. Such media may include, by way of illustration only and not limitation: magnetic, optical, magneto-optical, or other storage mechanisms, fixed or removable discs, drives, tapes, semiconductor memories, organic memories, CD-ROM, CD-R, CD-RW, DVD-ROM, DVD-R, DVD-RW, Zip, floppy, cassette, reel-to-reel, or the like. They may alternatively include down-the-wire, broadcast, or other delivery mechanisms such as Internet, local area network, wide area network, wireless, cellular, cable, laser, satellite, microwave, or other suitable carrier means, over which the instructions etc. may be delivered in the form of packets, serial data, parallel data, or other suitable format. The machine may include, by way of illustration only and not limitation: microprocessor, embedded controller, PLA, PAL, FPGA, ASIC, computer, smart card, networking equipment, or any other machine, apparatus, system, or the like which is adapted to perform functionality defined by such instructions or the like. Such drawings, written descriptions, and corresponding claims may variously be understood as representing the instructions etc. taken alone, the instructions etc. as organized in their particular packet/serial/parallel/etc. form, and/or the instructions etc. together with their storage or carrier media. The reader will further appreciate that such instructions etc. may be recorded or carried in compressed, encrypted, or otherwise encoded format without departing from the scope of this patent, even if the instructions etc. must be decrypted, decompressed, compiled, interpreted, or otherwise manipulated prior to their execution or other utilization by the machine.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A method for a first device and a second device to maintain synchronization of a shared, dynamic secret, the method comprising:
the second device sending an authentication request to the first device;
the first device, in response to the authentication request,
authenticating the second device,
sending an authentication reply to the second device, and
advancing a first copy of the secret;
the second device, in response to the authentication reply,
advancing a second copy of the secret;
the first device,
sending data to the second device,
again advancing the first copy of the secret, and
sending a data completion message to the second device;
the second device,
consuming the data, and
in response to the data completion message, again advancing the second copy of the secret.

2. The method of claim 1 wherein the first device comprises a server and the second device comprises a web appliance.

3. The method of claim 1 further comprising:
the first device storing the again advanced first copy of the secret; and
the second device storing the again advanced second copy of the secret.

4. The method of claim 1 further comprising:
executing a recovery technique in response to the first and second copies of the secret becoming out of synchronization.

5. A system for use on a network, the system comprising:
a server including,
a communication interface,
a processor for performing logic operations,
storage,
stored in the storage, a first copy of a secret,
a secret validator, and
means for advancing the first copy of the secret;
a web appliance including,
a communication interface coupling the web appliance to the server over the network,
a processor for performing logic operations,
storage,
stored in the storage of the web appliance, a second copy of the secret,
means for advancing the second copy of the secret; and
the server and the web appliance further including,
a protocol for recovering synchronization of the first and second copies of the secret.

6. The system of claim 5 wherein the secret comprises a PIN.

7. The system of claim 6 wherein the PIN comprises a number of at least 80 bits.

8. A method for a client device to maintain synchronization of a first copy of a secret stored on the client device with a second copy of the secret stored on a server device, the method comprising the client device:
sending an authorization request to the server device;
in response to receiving from the server device an authentication reply,
advancing the first copy of the secret; and
in response to receiving data from the server device,
consuming the data, and
again advancing the first copy of the secret.

9. The method of claim 8 further comprising the client device:
in response to receiving data from the server device,
storing the again advanced first copy of the secret.

10. The method of claim 8 further comprising the client device:
in response to not receiving an affirmative authentication reply from the server device,
(a) advancing the first copy of the secret,
(b) sending the advanced first copy of the secret to the server device.

11. The method of claim 10 wherein the (a) advancing the first copy of the secret comprises twice advancing the first copy of the secret.

12. A method for a server to authenticate an appliance that is in communication with the server, the method comprising the server:
receiving from the appliance an authentication request;
sending an authentication reply to the appliance;
advancing a first copy of a secret stored on the server;
sending data to the appliance;
sending a data completion message to the appliance;
again advancing the first copy of the secret; and
storing the again advanced first copy of the secret on the server.

13. The method of claim 12 wherein the secret is a PIN.

14. The method of claim 12 wherein the secret comprises a value of at least 80 bits.

15. The method of claim 12 further comprising:
determining that the appliance is not authentic and, responsive to that determination,
logging the authentication request, and
disconnecting communication to the appliance.

16. An article of manufacture comprising:
a machine-accessible medium including instructions that, when accessed by a machine, cause the machine to perform the method of claim 8.

17. The article of manufacture of claim 16 further comprising:
instructions that, when accessed by the machine, cause the machine to perform the method of claim 10.

18. An article of manufacture comprising:
a machine-accessible medium including instructions that, when accessed by a machine, cause the machine to perform the method of claim 12.

19. The article of manufacture of claim 18 further comprising:
instructions that, when accessed by the machine, cause the machine to perform the method of claim 15.
